(19) United States
(12) Patent Application Publication
(10) Pub. No.: US 2009/0183689 A1
(43) Pub. Date: Jul. 23, 2009

(54) Portable, rechargeable insect control apparatus and method of operation

(76) Inventors: Gary Stephen Moore, Dallas, TX (US); James B. Mills, Tyler, TX (US); Laura N. Van Nuland, Mansfield, MA (US); Christopher R. Yahnker, Raleigh, NC (US); John A. Venida, Raleigh, NC (US); James A. Borgen, Cary, NC (US); John A. Kaminski, Southborough, MA (US); Juliana G. Lear, Ipswich, MA (US); Gordon S. Jones, Needham, MA (US); Margaret F. Butler, Raleigh, NC (US); Peter Jerome Warren, Chicago, IL (US); Thomas H. Zelmer, Raleigh, NC (US)

Correspondence Address: Mr. Christopher John Rourk;Jackson Walker LLP, 901 Main Street, Suite 6000, DALLAS, TX, 75202, US

(21) Appl. No.: 12/009,684

(22) Filed: Jan. 22, 2008

(51) Int. Cl. A01K 29/00; G05B 19/00; B67D 5/08; B05B 7/32

(52) U.S. Cl. 119/712; 700/275; 239/71; 239/337

(57) ABSTRACT

A system for controlling insects is provided. The system includes an insect control compound reservoir. A pump receives an insect control compound from the insect compound reservoir and pressurizes the insect control compound. A rechargeable battery provides power to the pump. A plurality of nozzles receive the pressurized insect control compound and generate an insect control compound mist. A controller receives a first command to cause the pump to begin operation and a wireless signal to cause the pump to stop operation.

### FIELD OF THE INVENTION

The present invention relates to insect control systems, and more particularly to a portable, rechargeable insect control apparatus and method of operation.

### BACKGROUND OF THE INVENTION

Systems and methods for controlling insects are known in the art. Such prior art systems and methods include misting systems that generate a mist of an insect control compound by pressurizing the insect control compound and generating the mist by emitting the pressurized insect control compound through a nozzle that generates a mist.

### SUMMARY OF THE INVENTION

A portable, rechargeable insect control apparatus and method of operation are provided that provide safety features and a simplified user interface.

In particular, a portable, rechargeable insect control apparatus and method of operation are provided that prevent the insect control apparatus from being inadvertently activated in a confined area and that allow a user to interrupt operation of the insect control apparatus in order to relocate it as needed to provide a maximum coverage area.

In accordance with an exemplary embodiment of the invention, a system for controlling insects is provided. The system includes an insect control compound reservoir. A pump receives an insect control compound from the insect compound reservoir and pressurizes the insect control compound. A rechargeable battery provides power to the pump. A plurality of nozzles receive the pressurized insect control compound and generate an insect control compound mist. A controller receives a first command to cause the pump to begin operation and a wireless signal to cause the pump to stop operation.

The present invention provides many important technical advantages. One important technical advantage of the present invention is a system for controlling insects that can be readily located without consideration as to the availability of power sources, and which can be wirelessly disabled to allow a user to relocate the system where needed based on the mist distribution pattern.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for generating an insect control mist in accordance with an exemplary embodiment of the present invention;

FIG. 2 is a diagram of a system for providing a user controllable insect control mist apparatus in accordance with an exemplary embodiment of the present invention;

FIG. 3 is a diagram of a system showing the interior of an insect control apparatus in accordance with an exemplary embodiment of the present invention;

FIG. 4 is a diagram of a system for controlling an insect control compound mister in accordance with an exemplary embodiment of the present invention;

FIG. 5 is a flowchart of a method for operating an insect control apparatus in accordance with an exemplary embodiment of the present invention;

FIG. 6 is a diagram of a system showing a section view of an insect control apparatus in accordance with an exemplary embodiment of the present invention;

FIG. 7 is a diagram of system showing an overhead view of an insect control mist apparatus in accordance with an exemplary embodiment of the present invention; and

FIG. 8 is a diagram of a system for providing user controls for an insect control mist apparatus in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

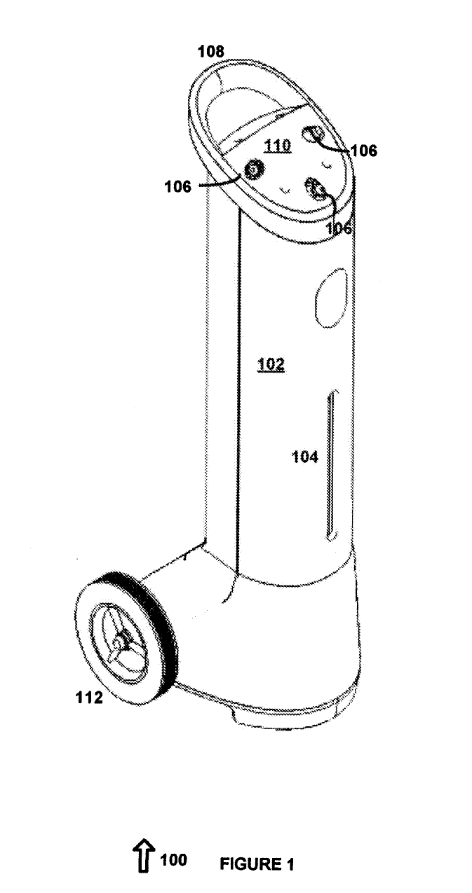

FIG. 1 is a diagram of a system 100 for generating an insect control mist in accordance with an exemplary embodiment of the present invention. System 100 allows the user to locate the insect control misting apparatus in a suitable location, and to disable the misting apparatus from a remote location in the event that the apparatus needs to be relocated.

System 100 includes housing 102, which can be formed from metal, molded plastic or other suitable materials. In one exemplary embodiment, housing 102 and other components of system 100 are formed from corrosion resistant, UV resistant, or other suitable weather resistant materials. Housing 102 includes tank fill indicator 104, which provides a visual indication of the fluid level of a tank contained within housing 102. In addition, upper surface 110 of housing 102 is disposed at an angle such that a plurality of nozzles 106 can be distributed on surface 110. Nozzles 106 can be stationary or user adjustable, such that the mist distribution pattern from nozzles 106 generates a maximum area of mist coverage. In one exemplary embodiment, nozzles 106 can be Hago 4023 nozzles available from Danfoss Hago Inc., 1120 Globe Avenue, Mountainside, N.J. 07092, or other suitable nozzles. Nozzles 106 are flush with or slightly elevated from upper surface 110, such that upper surface 110 protects nozzles 106 from damage. Upper surface 110 can be inclined at an angle 30 +/−5 degrees from horizontal, so as to increase the coverage area of insect control compound mist from nozzles 106.

In one exemplary embodiment, nozzles 106 can each be contained within a nozzle well that protects each nozzle 106 from damage while allowing each nozzle 106 to protrude from the surface a sufficient distance to allow the nozzle to disperse the insect control compound mist. In one exemplary embodiment, the height of nozzles 106 can be approximately ¾ of an inch to allow for the cone of the spray to clear the upper surface. In another exemplary embodiment, nozzles 106 can be attached to tubing that is stored within housing 102, such as to allow nozzles 106 to be removed and attached to suitable locations on a pole, fence, wall, or other structures. Nozzles 106 can also be removed, such as by unscrewing, and a nozzle attachment that includes tubing, a pole, clamps, a remote nozzle or other suitable components can be provided that is used in place of nozzles 106 as shown in FIG. 1.

Wheels 112 are attached to housing 102, such as using a bearing or other suitable devices to allow wheels 112 to rotate so as to allow system 100 to be manually located. A motor can also be provided so as to allow powered movement of wheels 112. Likewise, handle 108 can be used to move system 100, such as by orienting housing 102 at an angle and using handle 108 to push or pull system 100.

In one exemplary embodiment, each nozzle 106 can provide an 80 degree coverage area for generated insect control mist when 160+/−10 pounds per square inch (psi) of pressure is provided by a pump for an insect control compound (such as insecticide, an insect control product, or insect control concentrate) that is provided to each nozzle 106, such as to provide the insect control compound at a pressure of 150+/−10 psi at each nozzle 106 of an insect control compound mist having an approximately 45 to 50 micron particle size. The configuration of nozzles 106 shown in FIG. 1 can thus provide approximately a 180 degree insect control compound mist coverage area, assuming negligible wind effects or intervening structures. Likewise, the height of each nozzle 106 can be optimized for a portable system such as system 100, such as where a height of at least approximately 3 feet is provided to generate an optimal mist coverage area (as discussed below, telescoping or extendable nozzles can alternatively be provided to increase the height of the nozzles). The size of wheels 112 can also be optimally sized at 8 inches in diameter, such as where a smaller wheel will result in greater difficulty in movement of system 100 over normal terrain (such as grass, sidewalks, or other typical terrain). In this exemplary embodiment, the optimal sizes are based on the effective coverage area for control of flying insects as a function of manufacturing cost for system 100. Thus, while a larger or smaller coverage area can be obtained by increasing or decreasing the number of nozzles, the operating pressure, or other system parameters, or where additional ease of movement over rougher terrain can be realized by providing a larger wheel diameter, for an average treatment area defined by an average surface area of the backyard of a single family residence, the dimensions provided for this exemplary embodiment result in a minimization of manufacturing cost without a significant decrease in system 100 effectiveness.

In operation, system 100 allows a user to locate an insect control mist apparatus in a location so as to provide optimal exposure of a predetermined area to an insect control mist. In one exemplary embodiment, the user can place system 100 in a location based upon a prevailing wind direction, a configuration of the area in which the insect control mist is to be applied, or based on other suitable considerations. Nozzles 106 can disperse an insect control mist in a pattern that maximizes the amount of area that can be covered by the insect control mist to control flying insects for a predetermined period of time, assuming that sufficient pump pressure, atmospheric conditions, and other system and environment conditions do not interfere with system 100 operation. In one exemplary embodiment, flying insect control for approximately 2,000 square feet of surface area can be provided by the mist generated using system 100, such as when system 100 operates for a period of approximately 170 seconds or other suitable periods.

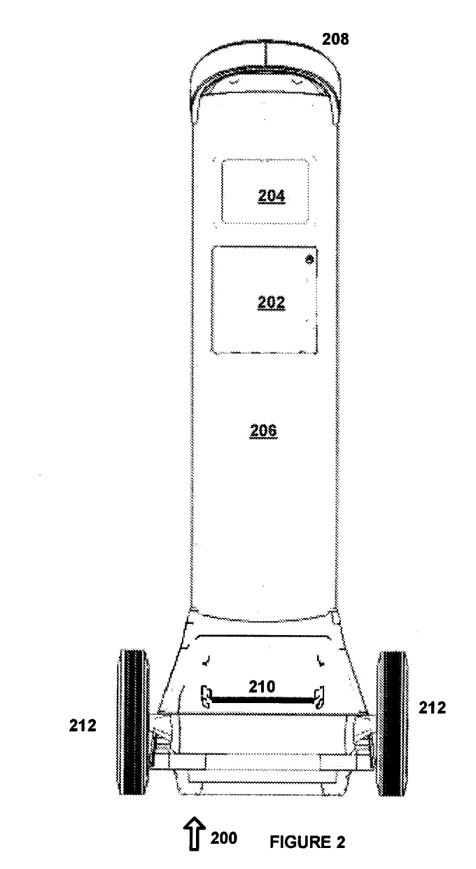

FIG. 2 is a diagram of a system 200 for providing a user controllable insect control mist apparatus in accordance with an exemplary embodiment of the present invention. System 200 includes access panel 202, which provides access to a tank refill cap, a master control switch, a recharge plug, and other suitable controls. In one exemplary embodiment, access control panel 202 can also include a lock or other mechanism to prevent children from inadvertently activating system 200.

System 200 includes housing 206 with wheels 212 and foothold 210, which can be used in conjunction with handle 208 to allow a user to manually relocate system 200, such as by changing the orientation of system 200 from a vertical operating position to an inclined orientation to allow system 200 to be manually pushed or pulled to a suitable user-selected location. Because the location in which system 200 can be operated will have varying boundaries, equipment (such as pools, food preparation surfaces, or other items on which an insect control compound mist may accumulate), atmospheric conditions, and other factors, a user needs to locate system 200 based on an expected mist distribution and to relocate unit 200 based on an actual mist distribution.

System 200 includes control panel 204. In one exemplary embodiment, control panel 204 contains a minimum number of controls that may be required for operation of system 200, or additional controls, such as controls for timing the operation of system 200 to operate at predetermined times, controls for changing the length of time that system 200 operates, or other suitable controls.

In operation, system 200 allows the user to relocate system 200 to a suitable location, provides safety features to prevent inadvertent operation of unit 200, such as operation when unit 200 is not configured for proper operation, or other suitable features.

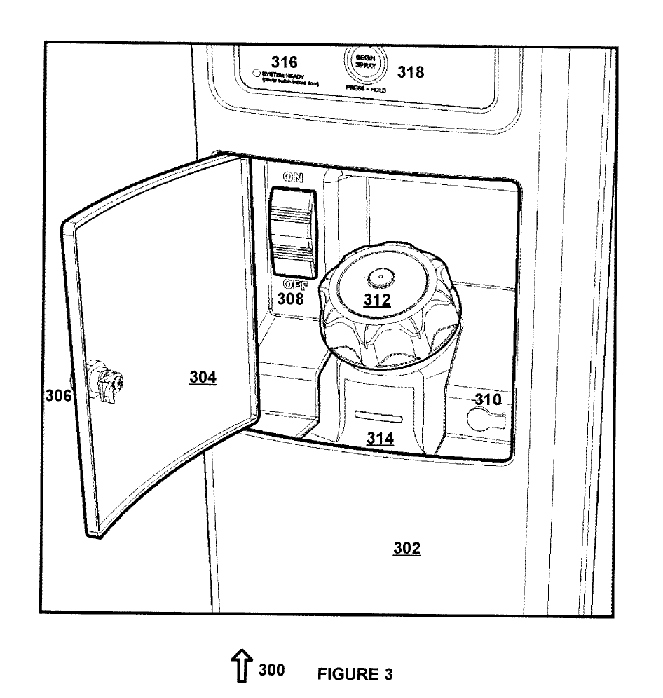

FIG. 3 is a diagram of a system 300 showing the interior of an insect control apparatus in accordance with an exemplary embodiment of the present invention. System 300 includes housing 302 and access panel 304, which is shown in an open configuration. Access panel 304 can be provided with a weatherproof seal so as to protect the internal components of system 300 from exposure to rain, moisture and other environmental conditions. Locking device 306 allows access panel 304 to be closed and secured so as to prevent access to the internal components of system 300. Locking device 306 can include a “child-proof” locking mechanism, a key-released locking mechanism, a latch, or other suitable locking mechanisms, and can also generate an inhibit signal so as to prevent operation of system 300 when access panel 304 is not secured.

Power switch 308 is located interior to the housing accessible through access panel 304, so as to prevent operation of unit 300 by operation of activation switch 314. In one exemplary embodiment, a user may first be required to activate power switch 308, at which point a system test may be performed by controlling logic of system 300 and other suitable processes can be performed. In this exemplary embodiment, a battery charge check, a reservoir fill check, or other suitable processes can be performed by the control logic.

Recharge plug 310 is located interior to the housing accessible through access panel 304. In one exemplary embodiment, system 300 can include a battery charge indicator that provides a visual indication of the amount of charge remaining for one or more rechargeable batteries of system 300. In another exemplary embodiment, when the rechargeable batteries of system 300 are being charged, a charging device is connected recharge plug 310, and control logic of unit 300 disables system 300. In this manner, system 300 cannot be inadvertently operated in a confined area, such as in a garage, patio, or other area where system 300 may be recharged.

Cap 312 can be removed by user to access an insect control compound reservoir 314 contained within housing 302. Insect control compound reservoir 314 contains a mixed solution of an insect control compound concentrate that has been diluted by water. In one exemplary embodiment, Vampyre™ Misting Concentrate, available from the McLaughlin Gormley King Company, 8810 Tenth Avenue North, Golden Valley, Minn. 55427, or other suitable concentrates can be used, such as where 4.3 oz. of concentrate are provided for each gallon of water or other dilutant. Cap 312 can be angled so as to allow a user to pour concentrated insect control compound into insect control compound reservoir 314, and also to fill the reservoir with water or other suitable dilutants. Cap 312 can then be replaced after insect control reservoir 314 has been filled. The control logic of system 300 can disable system 300 from operation when cap 312 is removed, such as by including a cap placement sensor or other suitable sensors.

Activation control 318 can be used to activate the unit after activation of power switch 308. In one exemplary embodiment, activation control 318 can be disabled if there is insufficient fluid in the reservoir, or the reservoir fill determination can be made after a user depresses activation control 318. Likewise, after a user depresses activation control 314, an audible indication can be generated that notifies the user that the user has a predetermined period of time to exit the vicinity of system 300 so as to avoid exposure to the insect control compound mist generated by system 300.

System ready light 316 can be used to provide an indication that battery charge, reservoir 314 fill level, cap 312 configuration, charger 310 configuration, or other suitable safety indications are acceptable, such that if system ready indication 316 is not activated, a user can be notified to investigate to determine what corrective action is required.

In operation, system 300 is used to control an insect control mist apparatus by providing multiple safety controls, and controls access to a reservoir fill cap, power switch, recharge plug, and other suitable system components.

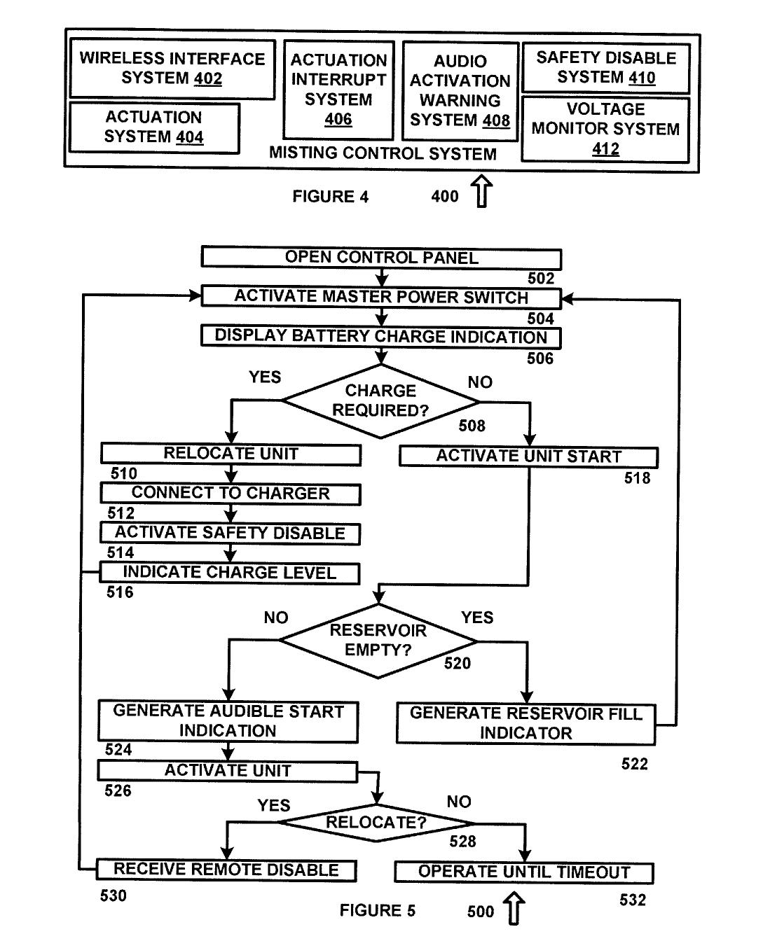

FIG. 4 is a diagram of a system 400 for controlling an insect control compound mister in accordance with an exemplary embodiment of the present invention. System 400 provides safety features that allow an insect control mister to be operated in a safe manner.

System 400 includes wireless interface system 402, actuation system 404, actuation interrupt system 406, audio activation warning system 408, safety disable system 410 and power monitor system 412, each of which can be implemented in hardware, software, or a suitable combination of hardware and software, and which can be one or more software systems operating on a general purpose processing platform, or other suitable platforms. As used herein, “hardware” can include a combination of discrete components, an integrated circuit, an application-specific integrated circuit, a field programmable gate array, a digital signal processor, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

Wireless interface system 402 allows the user to transmit an activate and disable command to an insect control misting apparatus. In one exemplary embodiment, wireless interface system 402 can be limited to disable commands so as to prevent users from activating an insect control mister unless additional safety steps have been performed. Likewise, wireless interface system 402 can be used to receive an actuation command, such as after a user has first activated a master power control switch or other suitable controls.

Actuation system 404 controls the activation of an insect control mister. In one exemplary embodiment, actuation system 404 can receive an activation system signal, can check for a safety disable signal, and can commence activation if no safety disable system is indicated. Actuation system 404 can include user-programmable run times or predetermined run time settings. In one exemplary embodiment, the length of time that an insect control mister operates may be determined to have a peak efficiency, such that operating the insect control mister for a period of time that is greater than or less than the predetermined time results in a less than optimal utilization of insect control compound. For the exemplary embodiment disclosed in FIGS. 1 and 2, an operation time of approximately three minutes has been determined to provide a 2000 square foot area with optimal flying insect protection for a period of two hours under normal environmental conditions, where the level of protection begins to fall off starting at two hours until a significantly reduced level of protection is reached at six hours, due to ingress of flying insects into the treated area. Factors such as wind, precipitation or other environmental factors may affect the area of coverage, length of time of coverage, or other coverage factors. In this exemplary embodiment, operation of the insect control mist apparatus for a period of time longer than three minutes does not provide an appreciable increase in either the treatment area or the length of time of insect reduction, so time settings can be fixed so as not to allow users to increase or decrease the length of time of operations.

Actuation interrupt system 406 receives an actuation interrupt signal and interrupts operation of the insect control mister. In one exemplary embodiment, wireless interface system 402 can receive an actuation interrupt signal that is provided to actuation interrupt system 406, which then causes insect control mister to be deactivated, such as by interrupting power to one or more pumps. In this exemplary embodiment, activation interrupt system 406 can reset the insect control mister so as to require a user to perform predetermined safety operations, such as after the insect control apparatus is relocated to a new location.

Audio activation warning system 408 generates an audio activation warning upon successful activation of the unit and performance of safety checks. In one exemplary embodiment, audio activation warning system 408 can provide a beep tone that increases in sound, frequency, timing, or in other suitable manners so as to allow a user to vacate the immediate area around insect control mist system prior to activation of the insect control mist system.

Safety disable system 410 generates a safety disable signal based on one or more predetermined inputs. In one exemplary embodiment, safety disable system 410 can determine whether an insect control mist system is being charged, has an open reservoir, has a low reservoir fluid level, has an open access panel, or has other safety disable indications, such as if the unit has been tipped over and a level indicator indicates that the unit should not be operated, if a motion detector detects motion indicating that a person or pet has entered the treatment area, if a wind detection system that measures wind speed has generated a safety disable signal if the wind speed exceeds a predetermined wind speed, if a power monitor system 412 disable signal has been received, or based on other suitable safety disable signals. Safety disable system 410 can also generate a disable system that is provided to actuation interrupt system 406 or other suitable systems.

Power monitor system 412 monitors battery voltage, pump current, and other suitable system power conditions and generates a disable signal if a system power parameter is outside of predetermined limits. In one exemplary embodiment, a disable signal can be generated if the battery voltage is determined to be below a predetermined level at which sufficient pump pressure is generated to provide the insect control compound at a pressure that will result in optimal insect control mist distribution. In this exemplary embodiment, the pressure generated by a pump can be a function of the battery voltage, such that when the measured battery voltage is below a predetermined level, the pump will not generate sufficient pressure to cause insect control compound mist dispersion over an effective area. In another exemplary embodiment, the current provided to the pump can be monitored and a disable signal can be generated if the current exceeds a predetermined maximum or minimum level. Power monitor system 412 monitors a battery voltage, pump current or other suitable power parameters and prevents operation of an insect control mister when insufficient or excessive operating voltage, insufficient or excessive current, or other conditions are present.

In operation, system 400 allows an insect control mister to be operated in a safe and easy manner, by reducing the number of user controls, by providing safety overrides, audio activation warnings, and other suitable controls.

FIG. 5 is a flowchart of a method 500 for operating an insect control apparatus in accordance with an exemplary embodiment of the present invention. Method 500 begins at 502, where a control panel is opened. In one exemplary embodiment, operation of the unit can be disabled unless the control panel is opened, such as to prevent inadvertent operation of the unit. The method then proceeds to 504.

At 504, a master power switch is activated. In one exemplary embodiment, the master power switch can be contained within the control panel, so as to prevent access to the master power switch by children and inadvertent operation of the unit. The method then proceeds to 506.

At 506, a battery charge indication is displayed. In one exemplary embodiment, the battery charge indication can allow the user to determine whether the unit requires a charge, can indicate that the unit has an insufficient charge to operate, or can provide other suitable indications. The method then proceeds to 508.

At 508, it is determined whether charging is required. In one exemplary embodiment, charging can be required in order to allow the unit to operate, a user can decide to provide a charge where a low charge indication has been provided but the unit has sufficient charge to operate or other suitable charge determinations can be made. If it is determined that a charge is required, the method proceeds to 510 where the unit is relocated, such as to an enclosed area that is protected from precipitation. The method then proceeds to 512 where the unit is connected to a charging apparatus, and the method proceeds to 514, where a safety disable control is activated, such as to prevent inadvertent operation of the unit in a confined space. The method then proceeds to 516 where a charge level is indicated. In one exemplary embodiment, the user can recharge the rechargeable batteries to a full charge state before proceeding, the user can charge the rechargeable batteries to a sufficient level to allow the insect control system to operate, or other suitable processes can be used. The method then returns to 504.

If it is determined at 508 that no charge is required the method proceeds to 518, where a unit start control is activated. The method then proceeds to 520 where it is determined whether there is sufficient fluid in a reservoir to allow the unit to operate. If it is determined that there is insufficient fluid in the reservoir, the method proceeds to 522 where a reservoir fill indication is generated, such as an audible alert, visual alert, or other suitable indication. The method then returns to 504, such as after a user removes a reservoir filled cap and refills the reservoir. Likewise, the reservoir fluid level check can be determined at system start-up or other suitable times.

If it is determined at 520 that there is no reservoir fill indication, the method proceeds to 524 where an audible start indication is generated. In one exemplary embodiment, the audible start indication can provide a number of beeps, such as of increasing frequency or timing, that allow the user to vacate the area in the vicinity of insect control misting apparatus prior to initiation of misting, so as to avoid exposure to the insect control compound mist. The method then proceeds to 526.

At 526, the unit is activated, such as by activating one or more pumps to pump the insect control compound from the reservoir at a pressure that generates a mist when the insect control compound is forced through a mist nozzle. The method then proceeds to 528.

At 528, it is determined whether relocation of the unit is required, such as based on the actual distribution of insect control compound mist, the prevailing winds, or other suitable conditions. If relocation is not required, the method proceeds to 532, where the unit operates until a predetermined period of time has elapsed, such as a period of time that provides a maximum level of exposure as a function of insect control compound or other suitable time periods. Otherwise, the method proceeds to 530 where a remote disable command is received. The remote disable command allows the user to disable the insect control misting apparatus without having to enter the insect control compound mist area or otherwise be exposed to the mist. The method then returns to 504.

In operation, method 500 allows an insect control misting apparatus to be operated in a manner that minimizes exposure to the insect control compound mist, that does not require manual timing of the unit, that provides safety features so as to prevent human exposure to insect control mist, and that provides other advantages.

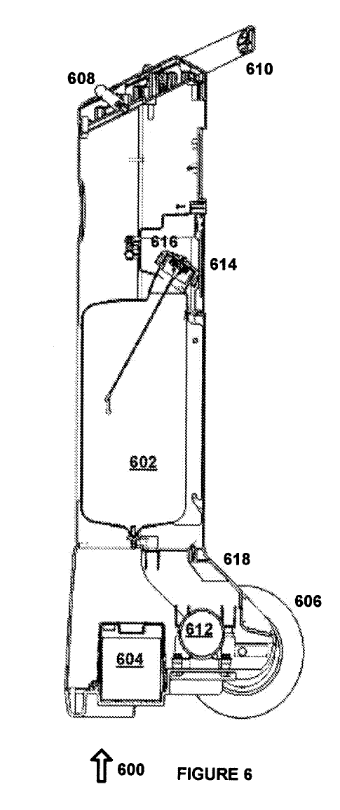

FIG. 6 is a diagram of a system 600 showing a section view of an insect control apparatus in accordance with an exemplary embodiment of the present invention. System 600 includes insect control compound reservoir 602, which can hold two gallons or other suitable amounts of insect control compound concentrate and dilutants, is accessible through access panel 614 and refill cap 616. Filter 620, which can be a fixed or removable wire mesh filter or other suitable filters, can be provided to prevent debris from being introduced into insect control compound reservoir 602. Rechargeable battery 604 and pump 612 are located at the base of system 600, and the location of insect control compound reservoir 602, rechargeable battery 604 and pump 612 provides additional vertical stability to system 600, by locating the heavier system components at a lower location. Likewise, a fuel cell, a solar power source, or other suitable power sources can be utilized, and a compressor, diaphragm pump, or other suitable devices for providing pressurized insect control compound to mist nozzle 608 or other suitable atomizing nozzles. Wheel 606 and foothold 618 can be used in conjunction with handle 610 to manually relocate system 600. Mist nozzle 608 is coupled to pump 612 through tubing (not explicitly shown), and receives pressurized insect control compound from insect control compound reservoir 602. Winterization plug 622 can be provided to allow insect control compound to be removed from insect control compound reservoir 602, such as by connection to a hose so as to prevent discharge of insect control compound to the environment.

In one exemplary embodiment, insect control compound reservoir 602 can be replaced by a sealed, pre-mixed, replaceable canister, such as by increasing the size of the access panel to allow insect control compound reservoir 602 to be removed when it is empty and replaced with a new full insect control compound reservoir 602. Likewise, a replaceable canister of insect control compound concentrate can be used in conjunction with a refillable water reservoir or a reservoir for other suitable dilutants.

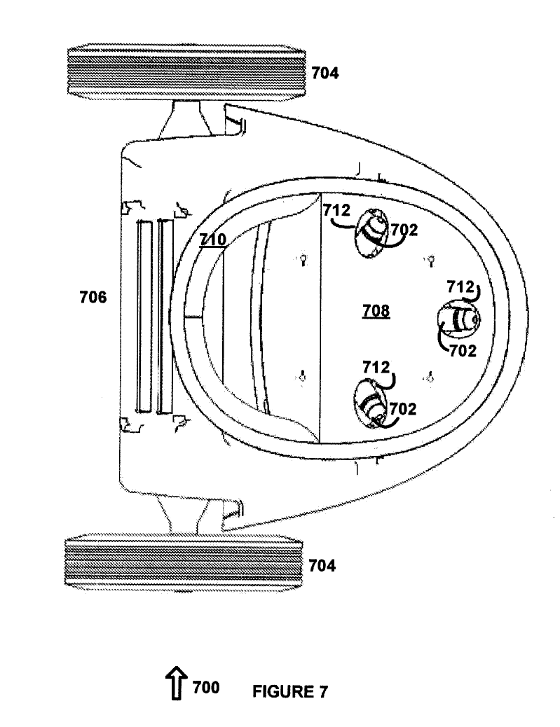

FIG. 7 is a diagram of system 700 showing an overhead view of an insect control mist apparatus in accordance with an exemplary embodiment of the present invention. A plurality of nozzles 702 are disposed on upper surface 708, which is angled so as to increase the insect control compound mist dispersion pattern to maximize the coverage area for the insect control compound mist. Handle 710, foothold 706 and wheels 704 can be used to allow system 700 to be manually located based on a user assessment of the area to which the insect control compound mist will be delivered, and to allow system 700 to be relocated if needed, such as to accommodate for prevailing wind and weather conditions. Each nozzle 702 is contained within a nozzle well 712, so as to protect the nozzles 702 from damage and dirt while allowing the nozzles to protrude far enough from surface 708 to deliver the insect control compound mist to the environment.

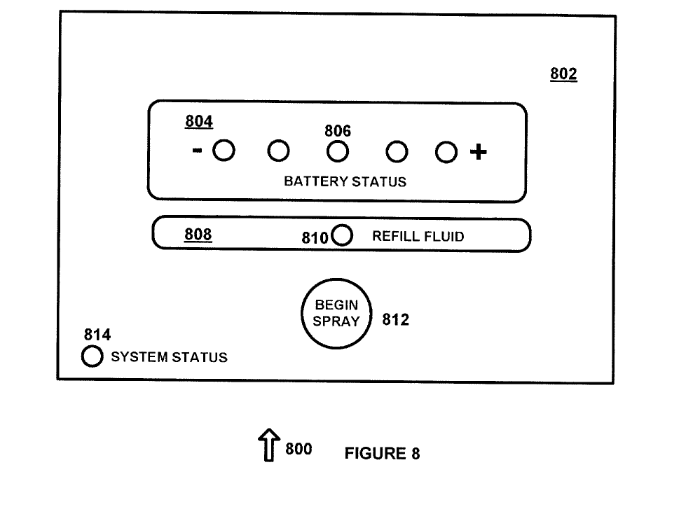

FIG. 8 is a diagram of a system 800 for providing user controls for an insect control mist apparatus in accordance with an exemplary embodiment of the present invention. System 800 includes control panel 802, which includes user control and information components. In one exemplary embodiment, control panel 802 can be a membrane-covered control panel, so as to provide user access to controls and to prevent exposure of control devices to the environment. Battery status indicator 804 provides a visual indication of the charge status of a rechargeable battery, such as by using a number of light emitting diodes (LEDs) 806 disposed between a minimum (−) and maximum (+) charge indicator. Insect control compound fluid level indicator 808 provides an indication when an insect control compound reservoir requires refilling, such as using an LED 810 that lights or changes color (such as from green to red) when the reservoir level is below a predetermined level. A system status LED 814 provides an indication of system status, such as by lighting or changing color (such as from green to red) when the system is inhibited from operation, such as when a battery charge control, a fluid level control, a reservoir cap condition control, or other suitable inhibit control signals prevent the insect control mist apparatus from operation.

System activation control 812 allows a user to initiate system operation, such as after depressing a button for a predetermined period of time, such as three seconds, so as to prevent inadvertent system operation. System activation control 812 can be disabled, such as if a master power control has not been activated, if rechargeable batteries of the insect control apparatus is being charged. or if other safety override control signals are present. In one exemplary embodiment, a power setting for the pump can also be provided, such as to increase or decrease the amount of mist that is generated, the coverage area, to accommodate different environmental conditions, or for other suitable purposes.

In operation, system 800 facilitates safe operation of an insect control mist apparatus by reducing the number of user-selectable controls to a minimum number of controls that is required for safe operation. While additional controls can be added in other exemplary embodiments, such as to allow a user to select the period of time that the insect control mist apparatus will operate, to allow a user to set a predetermined operating time and schedule, or to provide other suitable functionality, reducing the amount of user control to predetermined run times and manual activation can avoid overexposure of areas to insect control compounds and prevent inadvertent exposure to insect control compounds.

In view of the above detailed description of the present invention and associated drawings, other modifications and variations are apparent to those skilled in the art. It is also apparent that such other modifications and variations may be effected without departing from the spirit and scope of the present invention.

What is claimed is:

1. A system for controlling insects comprising:
an insect control compound reservoir;
a pump receiving an insect control compound from the insect compound reservoir and pressurizing the insect control compound;
a rechargeable battery providing power to the pump;
a plurality of nozzles receiving the pressurized insect control compound and generating an insect control compound mist; and
a controller receiving a first command to cause the pump to begin operation and a wireless signal to cause the pump to stop operation.

2. The system of claim 1 wherein the controller further comprises an audio activation warning system generating an audio activation warning after the controller receives the first command, wherein the controller delays operation of the pump until after the audio activation warning is generated.

3. The system of claim 1 wherein the plurality of nozzles are disposed on a surface and are each contained in a nozzle well set into the surface.

4. The system of claim 1 further comprising a safety disable system receiving one or more control signals and inhibiting operation of the controller.

5. The system of claim 1 further comprising a safety disable system receiving a recharge control signal and inhibiting operation of the controller.

6. The system of claim 1 further comprising a safety disable system receiving a reservoir cap control signal and inhibiting operation of the controller.

7. The system of claim 1 further comprising a safety disable system receiving a reservoir low control signal and inhibiting operation of the controller.

8. A system for controlling insects comprising:
an apparatus operable to generate an insect control compound mist;
an actuation system receiving two or more signals and causing the apparatus to operate or to cease operation based on the two or more signals;
an audio activation warning system generating one of the signals after completion of an audio activation warning; and
a safety disable system receiving a safety system status indicator and generating another of the signals.

9. The system of claim 8 wherein the safety system status indicator is a recharge signal.

10. The system of claim 8 wherein the safety system status indicator is a reservoir cap signal.

11. The system of claim 8 wherein the safety system status indicator is a reservoir level signal.

12. The system of claim 8 wherein the safety system status indicator is a wireless disable signal.

13. A method for insect control comprising:
manually placing an insect control apparatus in a user-selected location;
receiving a user activation control;
generating an audible warning signal for a predetermined period of time; and
generating an insect control mist after completion of the audible warning signal.

14. The method of claim 13 further comprising inhibiting operation of the insect control apparatus based on a safety signal.

15. The method of claim 13 further comprising inhibiting operation of the insect control apparatus based on a battery charging system signal.

16. The method of claim 13 further comprising inhibiting operation of the insect control apparatus based on a reservoir level signal.

17. The method of claim 13 further comprising:
receiving a wireless disable signal;
interrupting generation of the insect control mist; and
relocating the insect control apparatus based on a mist distribution pattern.
